(19) United States
(12) Patent Application Publication
(10) Pub. No.: US 2026/0289722 A1
(43) Pub. Date: Sep. 24, 2026

(54) IMAGE PROCESSING DEVICE, IMAGE PROCESSING METHOD, AND SYSTEM

(71) Applicant: CASIO COMPUTER CO., LTD., Tokyo (JP)

(72) Inventor: Yasushi MAENO, Tokyo (JP)

(73) Assignee: CASIO COMPUTER CO., LTD., Tokyo (JP)

(21) Appl. No.: 19/575,168

(22) Filed: Mar. 23, 2026

(30) Foreign Application Priority Data
Mar. 24, 2025 (JP) 2025-048156

(51) Int. Cl. G06T 3/14; G06T 7/00; G06T 7/70; G06V 10/25

(52) U.S. Cl. CPC G06T 3/14; G06T 7/0012; G06T 7/70; G06V 10/25; G06T 2207/30096

(57) ABSTRACT

An image processing device includes one or more processors to execute processing including: acquiring a first image in which a subject is captured; acquiring a second image in which the subject is captured that corresponds to a partial range within an image capturing range of the first image and that is captured under a same type of image capturing condition as the first image; performing position alignment between the first image and the second image; and arranging the second image at a position determined by the position alignment in the first image.

### CROSS-REFERENCE TO RELATED APPLICATIONS

This application claims the benefit of Japanese Patent Application No. 2025-048156, filed on Mar 24, 2025, the entire disclosure of which is incorporated by reference herein for all purposes.

### FIELD

This application relates to an image processing device, an image processing method, and a system.

### BACKGROUND

Conventionally, a technology for joining a plurality of images and generating a wide range image has been known. For example, Unexamined Japanese Patent Application Publication No. 2007-7307 discloses a technology for generating a subject image by performing position alignment on a plurality of X-ray images in such a way that overlapping portions of the plurality of X-ray images coincide with each other and joining and synthesizing the plurality of X-ray images with each other.

### SUMMARY

An image processing device according to the present disclosure includes one or more processors to execute processing including: acquiring a first image in which a subject is captured; acquiring a second image in which the subject is captured that corresponds to a partial range within an image capturing range of the first image and that is captured under a same type of image capturing condition as the first image; performing position alignment between the first image and the second image; and arranging the second image at a position determined by the position alignment in the first image.

### BRIEF DESCRIPTION OF DRAWINGS

A more complete understanding of this application can be obtained when the following detailed description is considered in conjunction with the following drawings, in which:

FIG. 1 is a diagram illustrating an overview of an image processing system according to Embodiment 1;

FIG. 2 is a block diagram illustrating a configuration of an image processing device according to Embodiment 1;

FIG. 3 is a diagram illustrating an example of a wide range image according to Embodiment 1;

FIG. 4A is a diagram illustrating a manner in which a user captures a wide range image;

FIG. 4B is a diagram illustrating a manner in which the user captures a close-up image;

FIG. 5 is a diagram illustrating an example in which an enlarged image is generated from the wide range image illustrated in FIG. 3;

FIG. 6 is a diagram illustrating an example of a close-up image according to Embodiment 1;

FIG. 7 is a diagram illustrating an example of a position of a close-up image determined by position alignment in the enlarged image illustrated in FIG. 5;

FIG. 8 is a diagram illustrating a first example of a synthesized image according to Embodiment 1;

FIG. 9 is a diagram illustrating a second example of the synthesized image according to Embodiment 1;

FIG. 10 is a diagram illustrating a third example of the synthesized image according to Embodiment 1;

FIG. 11A is a diagram illustrating another example of the synthesized image according to Embodiment 1;

FIG. 11B is a diagram illustrating still another example of the synthesized image according to Embodiment 1;

FIG. 12 is a flowchart illustrating a flow of processing executed by the image processing device according to Embodiment 1;

FIG. 13 is a diagram illustrating a first example of an instruction screen of close-up image capturing according to Embodiment 2; and

FIG. 14 is a diagram illustrating a second example of the instruction screen of the close-up image capturing according to Embodiment 2.

### DETAILED DESCRIPTION OF THE EMBODIMENTS

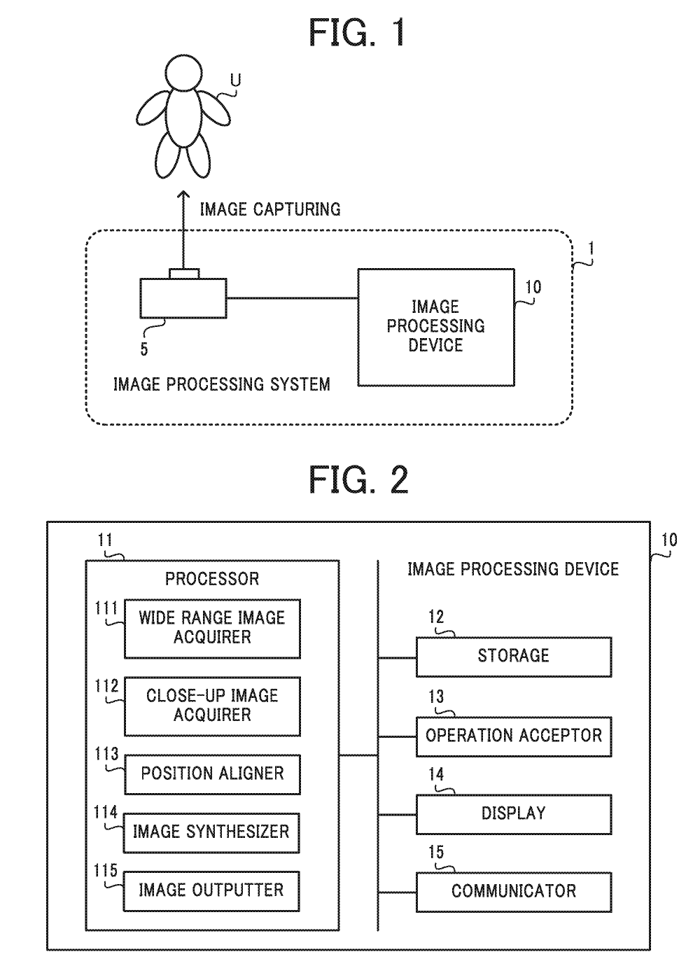

Embodiments of the present disclosure are described below with reference to the drawings. Note that the same or corresponding parts in the drawings are designated by the same reference numerals. An image processing system 1 according to Embodiment 1 is a medical assistance system for diagnosing a lesion candidate existing on the body of a subject U, based on a captured image in which the subject U is captured. The image processing system 1 includes an image capturing device 5 and an image processing device 10, as illustrated in FIG. 1.

The image capturing device 5 is a device that acquires a captured image in which the subject U is captured by capturing an image of the subject U using light of an appropriate wavelength, such as visible light, infrared light, and ultraviolet light. The image capturing device 5 is, as an example, a digital camera that a user can grasp by hand to capture an image at a clinical site. As used herein, the user is a diagnostician who diagnoses a lesion candidate, such as a doctor or medical care professional. Note that the image capturing device 5 may be a digital camera that is installed in a smartphone, a tablet terminal, or the like. A captured image captured by the image capturing device 5 is a medical image used for a medical purpose and is used to diagnose a lesion candidate existing on the body of the subject U.

The image capturing device 5 includes, although illustration is omitted, a lens that condenses incident light, an image sensor that receives light condensed by the lens, and a reading circuit that reads light received by the image sensor. The image sensor includes an imaging element, such as a charge coupled device (CCD) and a complementary metal oxide semiconductor (CMOS), and generates an image of the subject U. The reading circuit includes an analog/digital (A/D) converter, and converts an analog signal representing an image captured by the image sensor into digital data and outputs the digital data to the image processing device 10.

The image processing device 10 is a device operated by the user, and is, for example, an information processing device, such as a personal computer and a tablet terminal. The image processing device 10 acquires a captured image in which a lesion candidate existing on the body of the subject U is captured by the image capturing device 5, and executes image processing on the captured image. The image processing device 10 includes a processor 11, a storage 12, an operation acceptor 13, a display 14, and a communicator 15, as illustrated in FIG. 2.

The processor 11 includes a central processing unit (CPU), a read only memory (ROM), and a random access memory (RAM). The CPU includes a microprocessor and the like, and is a central operation processor that executes various types of processing and operation. In the processor 11, the CPU retrieves a control program stored in the ROM and, using the RAM as a work memory, controls overall operation of the image processing device 10. Note that processing performed by the processor 11 may be processing executed by only one CPU or processing executed by a plurality of CPUs. In addition, the processor 11 may include a processor dedicated for image processing, such as a digital signal processor (DSP) and a graphics processing unit (GPU).

The storage 12 is a nonvolatile memory, such as a flash memory and a hard disk. The storage 12 stores a program and data executed by the processor 11 as well as data generated by the processor 11. The operation acceptor 13 includes an input device, such as a keyboard, a mouse, and a touch panel, and accepts operation input from a user. The display 14 includes a display device, such as a liquid crystal display and an organic electro luminescence (EL) display, and displays various types of images under the control of the processor 11. The communicator 15 includes a communication interface to communicate with a device external to the image processing device 10. For example, the communicator 15 communicates with an external device including the image capturing device 5 in conformance with a communication standard, such as a local area network (LAN) and Universal Serial Bus (USB).

The processor 11 functionally includes a wide range image acquirer 111, a close-up image acquirer 112, a position aligner 113, an image synthesizer 114, and an image outputter 115. In the processor 11, the CPU functions as the above-described functional components by retrieving programs stored in the ROM into the RAM and executing the programs to perform control. Note that in the processor 11, a single CPU may function as each functional component, or a plurality of CPUs may function as each functional component in cooperation with one another.

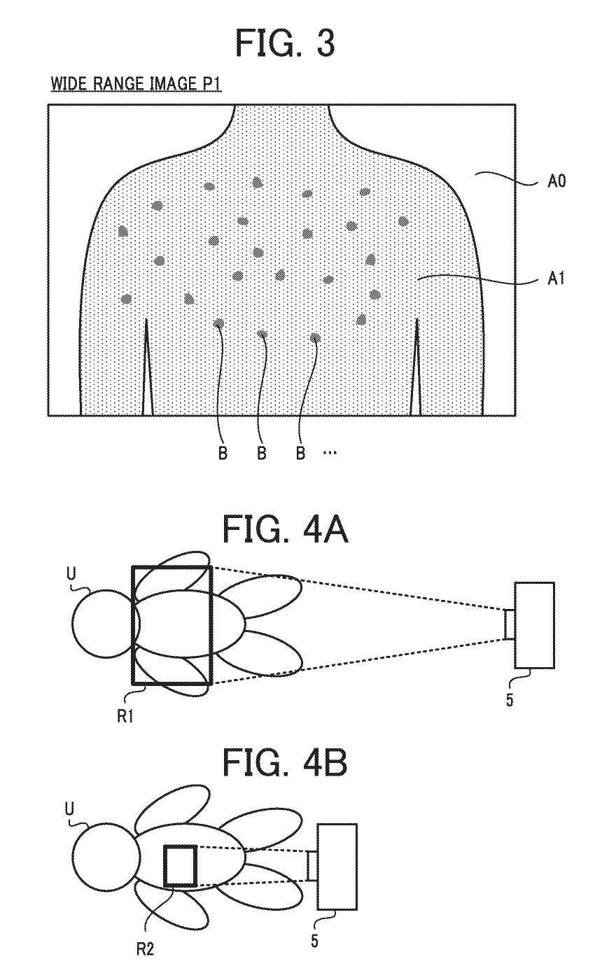

The wide range image acquirer 111 acquires a wide range image P1 in which a subject U is captured by the image capturing device 5. As used herein, the wide range image P1 is a captured image in which a wide range of the subject U is captured at one time for the user to observe a region encompassing a wide range of the subject U at one time. The wide range of the subject U is, for example, a range covering approximately a whole body or a half body of the subject U. The image capturing device 5 acquires, by capturing the subject U, a wide range image P1 illustrated in, for example, FIG. 3, as a captured image. More specifically, the wide range image P1 illustrated in FIG. 3 is an image of a wide range of the skin of an upper half body including the neck, the shoulders, the arms, and the like of the subject U, the image being captured from the front or the rear. In the wide range image P1, an area where the skin that is a portion of the body of the subject U is captured is referred to as a subject area A1, and an area other than the subject area A1 is referred to as a background area A0. The wide range image P1 is an example of a first image (whole image).

In the wide range image P1 illustrated in FIG. 3, a plurality of lesion candidates B is captured in the subject area A1. As used herein, the lesion candidate B refers to a site on the body of the subject U where there is a possibility that a pathological change has occurred, in other words, a site on the body of the subject U where some disease has developed. Examples of the lesion candidate B includes a site on the skin with a distinctive feature, such as a mole, a birthmark, and a spot. In addition, the lesion candidate B is only required to be a site where there is a possibility that a pathological change has occurred, and may be a site where a pathological change is actually occurring or a site where a detailed diagnosis result reveals that no pathological change has actually occurred.

When described in more detail, the wide range image acquirer 111 instructs the user to capture a wide range image. The wide range image acquirer 111 displays, on the display 14, a message instructing the user to capture a wide range image, such as "Please capture a wide range of the subject". Alternatively, the wide range image acquirer 111 may output such a message as sound from the speaker. When the user receives an instruction of wide range image capturing, the user operates the image capturing device 5 and captures the subject U with a desired range R1 as an image capturing range from a position relatively away from the subject U, as illustrated in FIG. 4A. As used herein, the range R1 for wide range image capturing is a range for generating a large image by joining a plurality of close-up images P3 to be described later. In the example in FIG. 4A, the range R1 corresponds to a wide range of the upper half of the body including the neck, the shoulders, the arms, and the like of the subject U. By capturing an image of such a range R1, a wide range image P1 illustrated in FIG. 3 can be obtained. The wide range image acquirer 111 acquires the wide range image P1 obtained through such wide range image capturing, from the image capturing device 5 by communicating with the image capturing device 5 via the communicator 15.

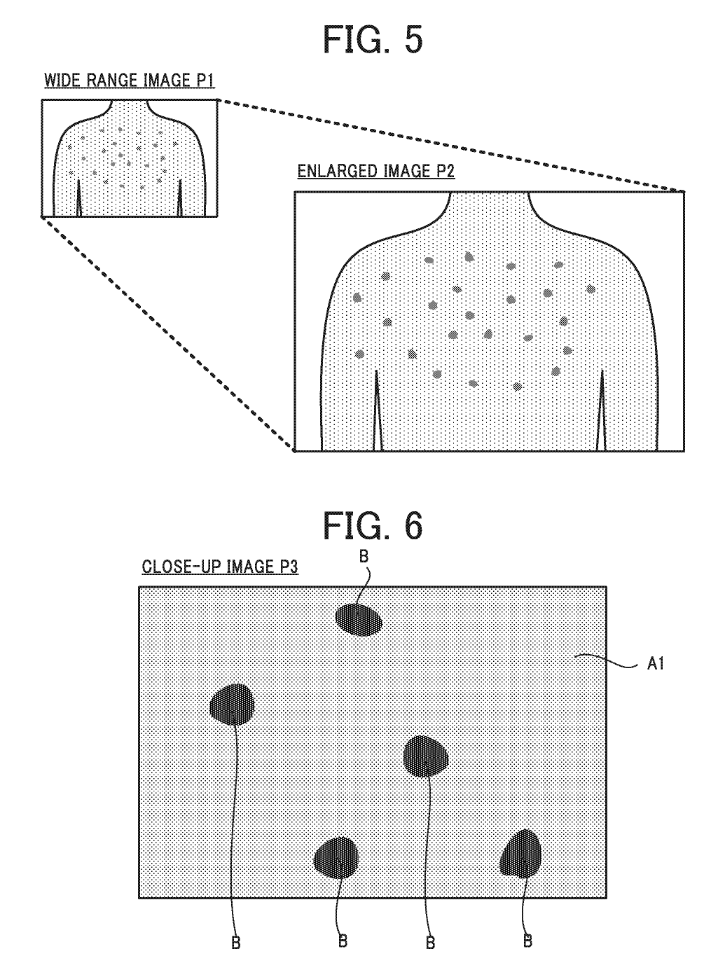

When the wide range image acquirer 111 acquires the wide range image P1, the wide range image acquirer 111 enlarges size of the acquired wide range image P1 and thereby generates an enlarged image P2, as illustrated in FIG. 5. Specifically describing, when size in the vertical direction and the lateral direction of the acquired wide range image P1 is U × V, the wide range image acquirer 111 enlarges the wide range image P1 by a predetermined ratio M and thereby generates an enlarged image P2 of size MU × MV in the vertical direction and the lateral direction. As used herein, the enlarged image P2 is an image for generating a synthesized image P4 by overlaying a plurality of close-up images P3 to be described later on the enlarged image P2. The predetermined ratio M is set to a ratio of approximately several times to more than 10 times according to a ratio R1/R2 of sizes of image capturing ranges between the wide range image P1 and the close-up image P3. Note that since the enlarged image P2 is an image obtained by enlarging the size of the wide range image P1, the enlarged image P2 is an example of the first image (whole image), as with the wide range image P1.

More specifically, the wide range image acquirer 111 generates two images, namely an image for reference and an image for synthesis, as the enlarged images P2 obtained by enlarging the size of the wide range image P1. The image for reference is an image for the user to refer to when capturing the close-up images P3 to be described later and is displayed on the display 14. In contrast, the image for synthesis is an image serving as an original image for generating a synthesized image P4 by overlaying the close-up images P3 on the image for synthesis.

Returning to FIG. 2, the close-up image acquirer 112 acquires a close-up image P3. As used herein, the close-up image P3 is a captured image captured by zooming in on a portion of the wide range image P1. In other words, the close-up image P3 is an image that corresponds to a partial range within the image capturing range of the wide range image P1 and is an image captured by the same image capturing device 5 as the image capturing device 5 used to generate the wide range image P1. The close-up image P3 is an example of a second image (partial image).

Specifically describing, after the wide range image P1 is acquired, the close-up image acquirer 112 instructs the user to capture a close-up image. The close-up image acquirer 112 displays an image for reference that is the enlarged image P2 obtained by enlarging the size of the wide range image P1, on the display 14. The close-up image acquirer 112 also displays, on the display 14, a message instructing the user to capture a close-up image, such as "Please capture a site of the subject that you desire to observe in detail". Alternatively, the close-up image acquirer 112 may output such a message as sound from the speaker. When the user receives an instruction to capture a close-up image, the user performs close-up image capturing with reference to the image for reference displayed on the display 14. Specifically, as illustrated in FIG. 4B, the user operates the image capturing device 5 and captures the subject U with a range R2, the range R2 being a portion of the range R1 in which the wide range image P1 is captured, as an image capturing range from a position relatively close to the subject U. In the example in FIG. 4B, the range R2 in the close-up image capturing corresponds to a partial range on the back of subject U. By capturing an image in such a range R2, a close-up image P3 illustrated in, for example, FIG. 6 is obtained.

The close-up image P3 illustrated in FIG. 6 is an image obtained by capturing a portion of the skin of the subject U from the front or the rear of the subject U. In the close-up image P3, some (in the example in FIG. 6, five lesion candidates B) of a plurality of lesion candidates B captured in the wide range image P1 are enlarged and captured. By using such a close-up image P3, the user can observe the lesion candidates B to the minutest detail compared with the wide range image P1. The close-up image acquirer 112 acquires the close-up image P3 obtained through such close-up image capturing, from the image capturing device 5 by communicating with the image capturing device 5 via the communicator 15.

When described in more detail, since the wide range image P1 and the close-up image P3 are images captured by the same image capturing device 5, the wide range image P1 and the close-up image P3 have the same number of pixels. Therefore, distance per pixel on the subject U is shorter for the close-up image P3 in which the relatively narrow range R2 is captured than for the wide range image P1 in which the relatively wide range R1 is captured. In other words, the close-up image P3 is an image captured with a higher spatial resolution than the wide range image P1 and enables a position on the subject U to be resolved and captured more finely than the wide range image P1. As described above, the wide range image P1 is an image suitable for observing a plurality of lesion candidates B existing in a wide range with a coarse spatial resolution at one time. In contrast, the close-up image P3 is an image with a higher spatial resolution than the wide range image P1 and is an image suitable for observing fine features of individual lesion candidates B.

Returning to FIG. 2, the position aligner 113 performs position alignment between the enlarged image P2 that is an image obtained by enlarging the size of the wide range image P1 and the close-up image P3. As described above, the close-up image P3 is an image in which a partial range within the image capturing range of the wide range image P1 is captured. The position aligner 113 identifies a position of the close-up image P3 within the enlarged image P2, based on a feature in the enlarged image P2 and a feature in the close-up image P3. In other words, the position aligner 113 identifies what range within the enlarged image P2 is captured into the close-up image P3.

Specifically describing, when performing the position alignment, the position aligner 113 detects at least one feature point from the enlarged image P2 and further detects at least one feature point from the close-up image P3. Next, the position aligner 113 identifies a correspondence relationship between the at least one feature point detected from the enlarged image P2 and the at least one feature point detected from the close-up image P3. The position aligner 113 performs the position alignment between the enlarged image P2 and the close-up image P3, based on the identified correspondence relationship between the feature points. As used herein, the feature point is a characteristic site included in an image. Specifically, the position aligner 113 detects a lesion area that is an area in which a lesion candidate B is captured, as a feature point from each of the enlarged image P2 and the close-up image P3.

To detect a lesion area as a feature point, the position aligner 113 first identifies a subject area A1 in which the skin that is a portion of the body of the subject U is captured, from each of the enlarged image P2 and the close-up image P3. Specifically describing, the position aligner 113 analyzes pixel values of pixels included in each of the enlarged image P2 and the close-up image P3, and identifies a subject area A1 from each of the enlarged image P2 and the close-up image P3, based on physical features, such as skin color and a shape of a region of the body.

When having identified the subject area A1, next, the position aligner 113 detects a lesion area in which a lesion candidate B is captured from within the identified subject area A1 in each of the enlarged image P2 and the close-up image P3. In other words, the position aligner 113 detects an area in which a site where there is a possibility that a pathological change has occurred on the body of the subject U is captured, from within the subject area A1 in which the skin of the subject U is captured. The position aligner 113, for example, detects an area containing numerous lesion candidates B captured in the enlarged image P2 from the enlarged image P2 illustrated in FIG. 5, and detects an area containing the five lesion candidates B captured in the close-up image P3 from the close-up image P3 illustrated in FIG. 6. To detect a lesion area, the position aligner 113 can use a known method relating to image identification. Since in general, brightness of a lesion area is relatively low and brightness in an area other than the lesion area is relatively high, the position aligner 113 detects an area where pixel values are relatively small, that is, an area that is relatively dark, compared with surroundings within the subject area A1, as a lesion area.

When having detected lesion areas, the position aligner 113 calculates a descriptor, such as a feature amount and a feature vector, with respect to a lesion area detected from each of the enlarged image P2 and the close-up image P3. For example, the position aligner 113 calculates a feature amount indicating brightness, size, a shape, and the like of a lesion area as the descriptor. Alternatively, the position aligner 113 may calculate a feature vector indicating distance, direction, and the like between two lesion areas as the descriptor.

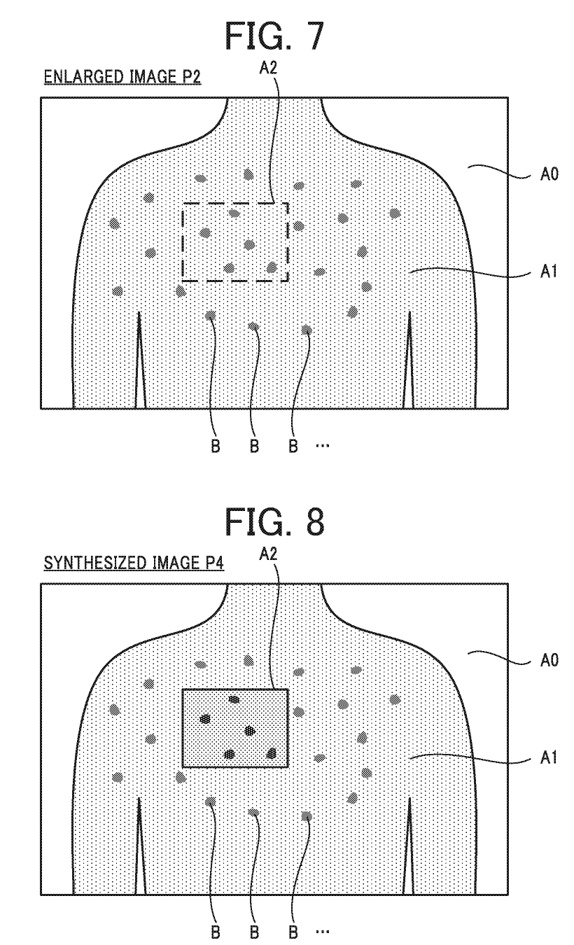

When having calculated a descriptor for each lesion area, the position aligner 113 performs position alignment between the enlarged image P2 and the close-up image P3, based on the calculated descriptors. Specifically describing, the position aligner 113 compares the descriptor of at least one lesion area detected from the enlarged image P2 with the descriptor of at least one lesion area detected from the close-up image P3 and identifies lesion areas that coincide with each other between the enlarged image P2 and the close-up image P3. In the example in FIGS. 5 and 6, the position aligner 113 identifies, among a plurality of lesion areas included in the enlarged image P2, five lesion areas that coincide with the five lesion areas included in the close-up image P3. The position aligner 113 identifies the position of the close-up image P3 within the enlarged image P2 in such a way that the five lesion areas included in the close-up image P3 are arranged at positions of the five lesion areas in the enlarged image P2 that are identified to coincide with the five lesion areas in the close-up image P3. As an example, the position aligner 113 identifies an area A2 that is illustrated by a dashed line in FIG. 7 as the position of the close-up image P3 within the enlarged image P2.

The position aligner 113 can use a known method to identify lesion areas that coincide with each other between the enlarged image P2 and the close-up image P3. As an example, the position aligner 113 can use a method, such as a k-nearest neighbors and random sample consensus (RANSAC). Specifically describing, the position aligner 113 calculates closeness (distance) of descriptors between lesion areas with respect to all possible combinations of one of the lesion areas in the enlarged image P2 and one of the lesion areas in the close-up image P3. The position aligner 113 selects k lesion areas from the plurality of lesion areas within the enlarged image P2 in descending (ascending) order of closeness (distance) between the descriptors with respect to each lesion area in the close-up image P3. The position aligner 113 identifies, based on the k lesion areas selected with respect to each lesion area in the close-up image P3, a lesion area that coincides with the lesion area in the close-up image P3, from within the enlarged image P2.

Returning to FIG. 2, the image synthesizer 114 arranges the close-up image P3 at a position determined by the position alignment performed by the position aligner 113, within the enlarged image P2. Through this processing, the image synthesizer 114 synthesizes the close-up image P3 with the enlarged image P2. Specifically describing, the image synthesizer 114 draws the close-up image P3 in the area A2 illustrated in FIG. 7 in the image for synthesis that is one of the two images generated based on the enlarged images P2, by overlaying the close-up image P3 over the image for synthesis. Through this processing, the image synthesizer 114 generates a synthesized image P4 illustrated in, for example, FIG. 8. In the synthesized image P4 illustrated in FIG. 8, while the area A2 is an image having a high spatial resolution since the close-up image P3 is drawn in the area A2, an area other than the area A2 remains as an image having a low spatial resolution since the area remains as the wide range image P1. Therefore, the synthesized image P4 is an image in which a lesion candidate B within the area A2 is drawn in such a manner as to enable the lesion candidate B to be observed to the minutest detail and a lesion candidate B in the area other than the area A2 is drawn with coarse precision.

Note that when synthesizing the close-up image P3 with the image for synthesis, the image synthesizer 114 performs geometric deformation (geometric correction) on the close-up image P3 as needed basis. Specifically describing, when image capturing angles and postures of the subject U are different between at the time of the wide range image capturing and at the time of the close-up image capturing, distortion occurs between the enlarged image P2 and the close-up image P3. To correct such distortion, the image synthesizer 114 deforms or rotates the close-up image P3, based on a relative positional relationship among a plurality of lesion areas captured in the close-up image P3 and the image for synthesis in such a way that the position of each lesion area in the close-up image P3 is arranged at the position of a corresponding lesion area in the image for synthesis, and subsequently synthesizes the close-up image P3 with the image for synthesis.

The image processing device 10 executes processing of acquiring the close-up image P3, performing the position alignment, and generating a synthesized image P4 as described above multiple times as needed. In other words, the close-up image acquirer 112 acquires a plurality of close-up images P3 each of which is an image in which a partial range of the image capturing range of the wide range image P1 is captured. The position aligner 113 performs position alignment between the enlarged image P2 and each of the plurality of close-up images P3. The image synthesizer 114 synthesizes each of the plurality of close-up images P3 with the enlarged image P2 by arranging the close-up image P3 at a position determined by the position alignment in the enlarged image P2.

Specifically describing, the close-up image acquirer 112 outputs a message inquiring of the user whether or not to perform additional close-up image capturing, via display or sound after the synthesized image P4 illustrated in FIG. 8 is generated. In a case where in response to such an inquiry, the user is to perform additional close-up image capturing, the user operates the image capturing device 5 and captures the subject U with an additional range R2 as an image capturing range. The additional range R2 is selected to be, although being a portion of the range R1 in which the wide range image P1 is captured, a different range from the range R2 through which a close-up image P3 has already been acquired, in order to capture an additional region of the subject U by the close-up image capturing operation. By performing close-up image capturing on the additional range R2, an additional close-up image P3 is obtained. In the additional close-up image P3, although illustration is omitted, a lesion candidate B that is different from the lesion candidate B already captured in the close-up image P3 is captured. The close-up image acquirer 112 acquires the additional close-up image P3 that is captured in this way from the image capturing device 5.

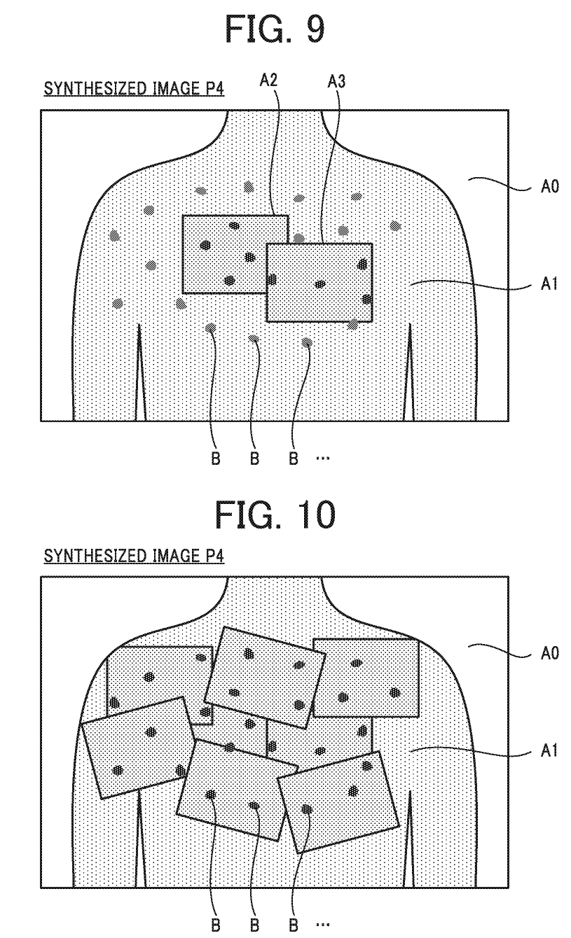

When the additional close-up image P3 is acquired, the position aligner 113 performs position alignment between the enlarged image P2 and the additional close-up image P3. Specific processing of the position alignment is the same as described above. The position aligner 113 identifies a position of the additional close-up image P3 within the enlarged image P2 through the position alignment. After the position alignment is performed, the image synthesizer 114 synthesizes the additional close-up image P3 with the synthesized image P4 illustrated in FIG. 8 by arranging the additional close-up image P3 at the position determined by the position alignment in the synthesized image P4. Through this processing, the image synthesizer 114 updates the synthesized image P4 as illustrated in, for example, FIG. 9. In the example in FIG. 9, the position determined by the position alignment is an area A3, and the image synthesizer 114 synthesizes the additional close-up image P3 with the synthesized image P4 by arranging the additional close-up image P3 in the area A3 within the synthesized image P4.

The image processing device 10 executes such processing of acquiring an additional close-up image P3, performing the position alignment, and generating the synthesized image P4, multiple times as needed. Through this processing, the image processing device 10 generates the synthesized image P4 with which a plurality of close-up images P3 is synthesized at various positions within the enlarged image P2, as illustrated in FIG. 10. Since the user can observe a region encompassing a wide range of the subject U to the minutest detail, using such a synthesized image P4, the user can perform a detailed diagnosis while comparing numerous lesion candidates B with one another.

Note that after the synthesized image P4 is generated by synthesizing one or more close-up images P3 with the enlarged image P2 as described above, the position aligner 113 performs the position alignment between the enlarged image P2 and an additional close-up image P3. On this occasion, the position aligner 113 may perform the position alignment between the enlarged image P2 before the one or more close-up images P3 are synthesized and the additional close-up image P3, or may perform the position alignment between the enlarged image P2 after the one or more close-up images P3 are synthesized (corresponding to the synthesized image P4 illustrated in, for example, FIGS. 8 or 9) and the additional close-up image P3. Since an area in which a close-up image P3 is synthesized has a higher spatial resolution than other areas, performing the position alignment using the enlarged image P2 after the close-up image P3 is already synthesized enables an advantageous effect that precision of the position alignment can be enhanced to be achieved.

In addition, in a case where at the time of synthesizing an additional close-up image P3 with the enlarged image P2 after one or more close-up images P3 are synthesized, an area in which the additional close-up image P3 is to be arranged overlaps an area in which a close-up image P3 has already been synthesized, the position aligner 113 may display, as an image in the overlapping portion, either the additional close-up image P3 or the close-up image P3 that has already been synthesized. For example, in FIG. 9, the area A2 of a close-up image P3 synthesized chronologically earlier and the area A3 of a close-up image P3 synthesized chronologically later overlap each other in part. In the example in FIG. 9, the position aligner 113 overwrites the close-up image P3 synthesized earlier with the close-up image P3 synthesized later in the overlapping portion and displays the close-up image P3 synthesized later as an image in the overlapping portion. However, the position aligner 113 may, without being limited to the configuration, display the close-up image P3 synthesized earlier as an image in the overlapping portion. Because of this configuration, for example, even when the position alignment is difficult to perform in a case where a lesion candidate exists on a boundary line of a close-up image synthesized later, displaying a close-up image synthesized earlier enables the lesion image to be viewed excellently in the close-up image synthesized earlier. Alternatively, the position aligner 113 may determine the pixel values of pixels in the overlapping portion by mixing the close-up image P3 synthesized earlier and the close-up image P3 synthesized later with each other by alpha blending or the like. On this occasion, the position aligner 113 may determine, by user operation, whether to display the close-up image P3 synthesized earlier, to display the close-up image P3 synthesized later, or to mix the two close-up images P3 with each other, as the image in the overlapping portion. In the case where the two close-up images P3 are mixed with each other, the user may specify a coefficient (α value) of the alpha blending that is a degree to which the two close-up images P3 are mixed with each other.

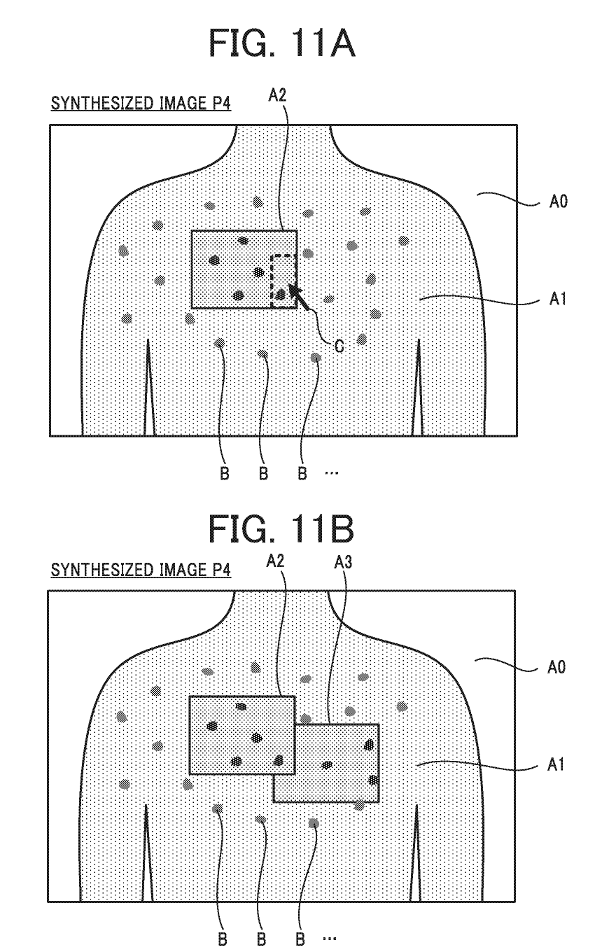

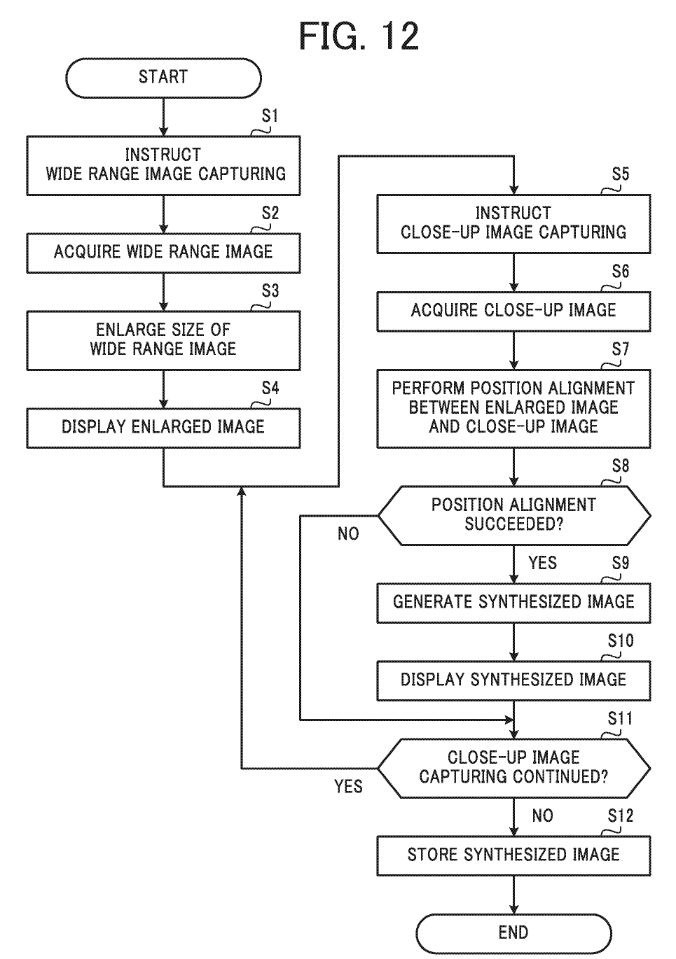

As an example, as illustrated in FIG. 11A, in a case where in the synthesized image P4 in which the close-up image P3 is synthesized in the area A2, the user desires to retain a portion or all of the close-up image P3 in the area A2 for a reason that image quality is good or the like, the user operates a cursor C and thereby specifies a priority range (a range indicated by a dashed line). The priority range is a range that, even in a case where an additional close-up image P3 is synthesized in the range, is not overwritten by the additional close-up image P3. In a case where after the priority range is specified as described above, an additional close-up image P3 is synthesized in the area A3 that overlaps the area A2 in the priority range as illustrated in FIG. 11B, the position aligner 113 displays the close-up image P3 in the area A2 that is synthesized earlier as an image in the priority range. In other words, in the priority range, the close-up image P3 in the area A2 synthesized earlier is retained without being overwritten by the close-up image P3 in the area A3 synthesized later. Alternatively, as another example, it may be configured such that after two close-up images P3 with overlapping portions are synthesized, the close-up image P3 displayed in the overlapping portion can be switched between the two close-up images P3. Specifically, in the synthesized image P4 after a plurality of close-up images P3 is synthesized as illustrated in FIG. 10, the user operates the cursor C and specifies one of the plurality of close-up images P3. In this case, the position aligner 113 may be configured to display a close-up image P3 specified by the user in front of the other overlapping close-up images P3 that have portions overlapping the specified close-up image P3.

Returning to FIG. 2, the image outputter 115 outputs a synthesized image P4 generated by the image synthesizer 114. The image outputter 115 displays the synthesized image P4 illustrated in, for example, FIGS. 8 to 10 on the display 14. Note that the image outputter 115 may output the synthesized image P4 to an external device via the communicator 15 and display the synthesized image P4 on a display of the external device. As described above, the synthesized image P4 is an image in which one or more close-up images P3 are synthesized with the enlarged image P2 that is a wide range image P1 the size of which is enlarged. Therefore, a diagnostician, such as a doctor and a medical care professional, can, by observing the synthesized image P4 displayed on a display screen, observe a plurality of lesion candidates B existing in a wide range of the subject U at one time and to the minutest detail of each lesion candidate B. Since because of this capability, it is possible to observe fine features of individual lesion candidates B while comparing the fine features among a plurality of lesion candidates B, diagnosis with high precision can be achieved.

Next, a flow of processing executed by the image processing device 10 is described with reference to FIG. 12. The processing illustrated in FIG. 12 is executed at an appropriate timing for the user to diagnose a lesion candidate B of the subject U. The processing illustrated in FIG. 12 is an example of an image processing method. When the processing is started, first, the processor 11 instructs the user to perform the wide range image capturing (step S1). Specifically describing, the processor 11 outputs a message instructing the user to perform the wide range image capturing, via display or sound. The user operates the image capturing device 5 and captures a desired range R1 of the subject U in accordance with the instruction of the wide range image capturing, as illustrated in, for example, FIG. 4A. The processor 11 acquires a wide range image P1 captured in this way from the image capturing device 5 (step S2). Next, the processor 11 enlarges the size of the wide range image P1 and thereby generates an enlarged image P2 (step S3) and displays the generated enlarged image P2 (step S4). In steps S1 to S4, the processor 11 functions as the wide range image acquirer 111.

When having acquired the wide range image P1, the processor 11 instructs the user to perform the close-up image capturing (step S5). Specifically describing, the processor 11 outputs a message instructing the user to perform the close-up image capturing, via display or sound. The user operates the image capturing device 5 and captures a desired range R2 of the subject U in accordance with the instruction of the close-up image capturing, as illustrated in, for example, FIG. 4B. The processor 11 acquires a close-up image P3 captured in this way from the image capturing device 5 (step S6). In steps S5 to S6, the processor 11 functions as the close-up image acquirer 112.

When having acquired the close-up image P3, the processor 11 performs position alignment between the enlarged image P2 generated in step S3 and the close-up image P3 acquired in step S6 (step S7). Specifically describing, the processor 11 detects at least one feature point from each of the enlarged image and the close-up image P3, and identifies a correspondence relationship in the feature points between the enlarged image and the close-up image P3. The processor 11 identifies the position of the close-up image P3 within the enlarged image P2, based on the correspondence relationship in the feature points. Next, the processor 11 determines whether or not the position alignment has succeeded (step S8). The processor 11 determines that the position alignment has succeeded when a position corresponding to the close-up image P3 is identified in the enlarged image P2. In contrast, in a case where the close-up image P3 is an image unrelated to the wide range image P1 as in a case where, for example, the outside of the image capturing range of the wide range image P1 is captured as the close-up image capturing, it is not possible to identify the position corresponding to the close-up image P3 within the enlarged image P2. In this case, the processor 11 determines that the position alignment has failed. In steps S7 and S8, the processor 11 functions as the position aligner 113.

In the case where the position alignment has succeeded (step S8; YES), the processor 11 functions as the image synthesizer 114 and generates a synthesized image P4 (step S9). Specifically describing, the processor 11 overlays the close-up image P3 on the enlarged image P2 at the position identified by the position alignment within the enlarged image P2. On this occasion, the processor 11 deforms or rotates the close-up image P3 as needed basis. Through this processing, the processor 11 generates a synthesized image P4 in which the close-up image P3 is arranged in a portion within the enlarged image P2, as illustrated in, for example, FIG. 8. When having generated the synthesized image P4, the processor 11 functions as the image outputter 115 and displays the generated synthesized image P4 on the display 14 (step S10). In contrast, in the case where the position alignment in step S7 has failed (step S8; NO), the processor 11 skips steps S9 and S10.

Next, the processor 11 determines whether or not to continue the close-up image capturing (step S11). Specifically describing, the processor 11 outputs a message inquiring whether or not to continue the close-up image capturing via display or sound. In a case where an operation indicating intention to continue the close-up image capturing is input by the user, the processor 11 determines that the close-up image capturing is to be continued. In the case where the close-up image capturing is to be continued (step S11; YES), the processor 11 returns the process to step S5 and executes the processing in steps S5 to S10 again. Specifically describing, the processor 11 acquires an additional close-up image P3, performs the position alignment, and further synthesizes the additional close-up image P3 with the synthesized image P4 generated in step S9. Through this processing, the processor 11 generates the synthesized image P4 as illustrated in, for example, FIG. 9. In this way, the processor 11 repeatedly executes the processing in steps S5 to S10 in accordance with the user operation. Through this processing, the processor 11 generates the synthesized image P4 in which a plurality of close-up images P3 is synthesized, as illustrated in, for example, FIG. 10. Subsequently, in a case where the close-up image capturing is to be terminated (step S11; NO), the processor 11 stores the finally generated synthesized image P4 (step S12). Consequently, the processing illustrated in FIG. 12 terminates.

As described in the foregoing, the image processing device 10 according to Embodiment 1 acquires a wide range image P1 in which a subject U is captured by the image capturing device 5, and acquires a close-up image P3 in which a partial range within the image capturing range of the wide range image P1 is captured by the same image capturing device 5. The image processing device 10 according to Embodiment 1 performs position alignment between an enlarged image P2 obtained by enlarging the wide range image P1 and the close-up image P3, arranges the close-up image P3 at a position determined by the position alignment in the enlarged image P2, and thereby generates a synthesized image P4. As described above, the image processing device 10 according to Embodiment 1 performs the position alignment of the close-up image P3 with reference to the enlarged image P2. Since because of this configuration, the position alignment can be performed with high precision, the enlarged image P2 and the close-up image P3 or a plurality of close-up images P3 can be joined with each other with high precision. As a result, it is possible to accurately generate the synthesized image P4 in which a wide range is captured.

For example, as a method for performing position alignment of a plurality of close-up images P3 without using the enlarged image P2, there is a method for stitching the plurality of close-up images P3 by making use of an overlapping portion between the plurality of close-up images P3. However, in a case where the overlapping portion is small, it is difficult to perform the position alignment with sufficient precision, particularly when images are captured with the image capturing device 5 held by hand. In contrast, in Embodiment 1, since the position alignment of the close-up image P3 is performed with the wide range image P1 as a reference, it is possible to perform the position alignment with high precision and thereby improve the precision of the stitching.

In particular, although it is difficult to observe details of the subject U using only the wide range image P1, the image processing device 10 according to Embodiment 1 synthesizes a close-up image P3 that is captured with higher spatial resolution than the wide range image P1 at a corresponding position within the enlarged image P2. Therefore, it is possible to observe a region encompassing a wide range of the subject U at one time and obtain one captured image that enables the subject U to be observed to the minutest detail. Since as a result, the diagnostician can observe a plurality of lesion candidates B existing in a wide range of the body of the subject U in detail at one time, improvement in diagnostic precision can be achieved.

In addition, the image processing device 10 according to Embodiment 1 is capable of obtaining such a captured image using a simple method without requiring large-scale equipment. For example, as another method for obtaining a captured image that enables a subject to be observed over a wide range and to the minutest detail, there is a method for performing image capturing with an image capturing range narrowed multiple times by gradually shifting an image capturing position and joining a plurality of images obtained through the image capturing. Although in this method, it is unnecessary to perform position alignment between a plurality of captured images by image processing, large-scale equipment becomes necessary since a mechanism to control the image capturing position with high precision is required. In contrast, in Embodiment 1, capturing of a close-up image P3 can be easily performed by the user grasping the image capturing device 5 by hand without using large-scale equipment. Therefore, it is possible to obtain an image that enables the subject U to be observed over a wide range and to the minutest detail with a simple method.

Next, Embodiment 2 is described. Descriptions of the same constituent components and functions as those in Embodiment 1 are omitted as appropriate. In Embodiment 1 described above, the close-up image acquirer 112 instructs the user to perform close-up image capturing when acquiring a close-up image P3. In contrast, in Embodiment 2, a close-up image acquirer 112 displays a target position for close-up image capturing when instructing a user to perform close-up image capturing.

Specifically describing, after a wide range image acquirer 111 acquires a wide range image P1 and generates an enlarged image P2, the close-up image acquirer 112 detects at least one area of interest from within the enlarged image P2. As used herein, the area of interest is an area in which a target that the user desires to observe is captured in the wide range image P1 and the enlarged image P2. Specifically, the area of interest corresponds to a lesion area in which a lesion candidate B is captured. The close-up image acquirer 112 detects at least one lesion area from within the enlarged image P2. A method for the close-up image acquirer 112 to detect a lesion area is the same as the method described in Embodiment 1 for a position aligner 113 to detect a lesion area from the enlarged image P2.

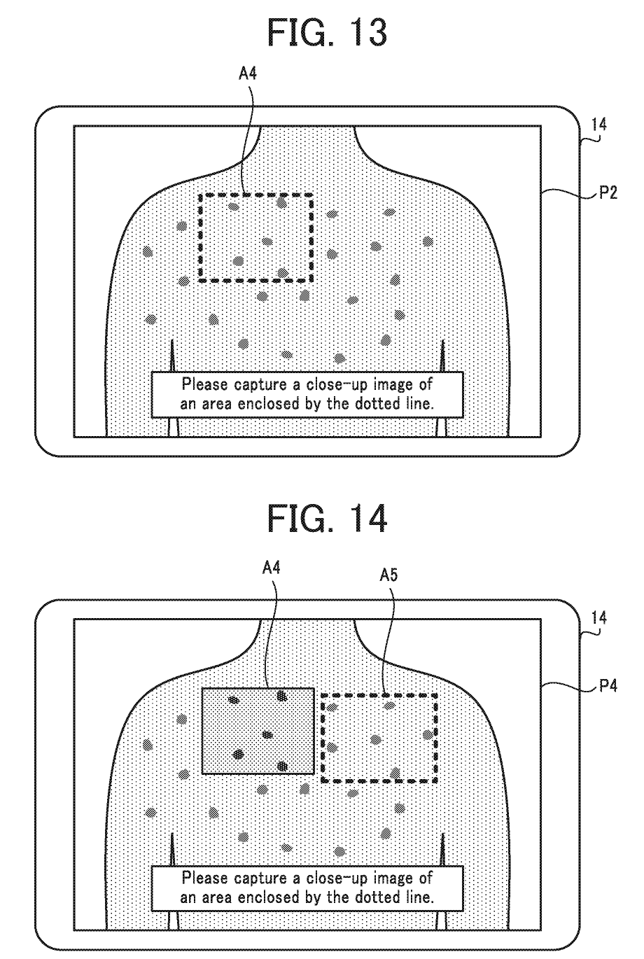

After detecting at least one lesion area as an area of interest, the close-up image acquirer 112 displays a position of the detected lesion area as a target position when the user captures the close-up image P3. The close-up image acquirer 112 instructs the user to capture the position of the detected lesion area. Specifically, as illustrated in FIG. 13, the close-up image acquirer 112 displays the enlarged image P2 on a display 14 when instructing the user to perform close-up image capturing. The close-up image acquirer 112 displays an area A4 including the detected lesion candidate as a target position when the user performs the close-up image capturing, in the displayed enlarged image P2. The area A4 is equivalent to a range that is captured in a single close-up image capturing performed by an image capturing device 5. In such a display screen, the close-up image acquirer 112 displays a message instructing the user to perform the close-up image capturing on the displayed area A4. Through this processing, the close-up image acquirer 112 instructs the user about the target position for the close-up image capturing.

More specifically, in a case where as illustrated in FIG. 13, a plurality of lesion areas is detected and the plurality of detected lesion areas is distributed over a wide range, there are some cases where the plurality of lesion areas does not fit within a range captured by a single close-up image capturing performed by the image capturing device 5. In this case, the close-up image acquirer 112 displays the area A4 that includes some of the plurality of detected lesion areas as the target position for the close-up image capturing. On this occasion, the close-up image acquirer 112 determines the position of the area A4, based on a density distribution within the enlarged image P2 of the plurality of lesion areas detected from within the enlarged image P2. As used herein, the density distribution of lesion areas is equivalent to the number of lesion areas per unit area. When determining a target position for the close-up image capturing, the close-up image acquirer 112 refers to the density distribution of lesion areas within the enlarged image P2. The close-up image acquirer 112 determines a site where lesion candidates are concentrated in the enlarged image P2 as the position of the area A4 in such a way that the number of lesion areas located within the area A4 is maximized. By determining the target position of a close-up image, based on the density distribution of the lesion areas as described above, it is possible to obtain a close-up image P3 that enables a lot of lesion candidates B to be efficiently observed in the case where a plurality of lesion candidates B is dispersed over a wide range of a subject U.

After the target position for the close-up image capturing is displayed in this way, the user operates the image capturing device 5 and performs the close-up image capturing with reference to the displayed target position. The close-up image acquirer 112 acquires a close-up image P3 obtained through the close-up image capturing from the image capturing device 5. The position aligner 113 performs position alignment between the enlarged image P2 and the close-up image P3, and an image synthesizer 114 arranges the close-up image P3 at a position determined by the position alignment in the enlarged image P2 and thereby generates a synthesized image P4.

In a case where after the close-up image P3 is acquired and the synthesized image P4 is generated as described above, the user performs additional close-up image capturing, the close-up image acquirer 112 displays a target position for the additional close-up image capturing on the display 14. Specifically, as illustrated in FIG. 14, the close-up image acquirer 112 displays the synthesized image P4 obtained by synthesizing the close-up image P3 with the enlarged image P2 on the display 14. The close-up image acquirer 112 displays an area A5 different from the area A4 as a target position when the user performs the additional close-up image capturing, in the displayed synthesized image P4. As used herein, the area A5 is determined to be a different area from the area A4 in such a way that a lesion area other than the lesion areas already captured in the close-up image P3 can be captured. The different close-up image capturing areas A4 and A5 do not have to have an overlapping portion as illustrated in FIG. 14, or may have an overlapping portion.

More specifically, the close-up image acquirer 112 determines the position of the area A5 that includes a lesion area other than the at least one lesion area already captured in the close-up image P3 among the plurality of lesion areas detected from the enlarged image P2. On this occasion, the close-up image acquirer 112 determines the position of the area A5, based on the density distribution of the lesion areas in such a way that the number of lesion areas located within the area A5 is maximized, as with the determination of the area A4. As described above, the close-up image acquirer 112 determines the target position for the close-up image capturing in such a way that a different lesion candidate B is captured and displays the target position on the display 14 every time the user performs the close-up image capturing. Through this processing, the user can efficiently perform close-up image capturing of a plurality of lesion candidates B dispersed over a wide range.

As described in the foregoing, an image processing device 10 according to Embodiment 2 detects a lesion area from within the enlarged image P2 and displays a position of the detected lesion area as a target position when the user captures a close-up image P3. In addition, in a case where a plurality of lesion areas is detected from within the enlarged image P2, the image processing device 10 according to Embodiment 2 determines a target position for the close-up image capturing, based on a density distribution of the plurality of lesion areas. Since because of this configuration, it is possible to omit capturing of a portion with a low degree of importance and capture a portion with a high degree of importance in a focused manner, efficiency of the close-up image capturing can be improved.

In the prior art, in a case where an overlapping area between images is small, it is difficult to achieve accurate position alignment between images and join a plurality of images with high precision. The present disclosure enables a plurality of images to be joined with each other with high precision.

Although the embodiments of the present disclosure are described above, the above-described embodiments are only examples, and the scope of application of the present disclosure is not limited to the embodiments. That is, various applications of the embodiments of the present disclosure are possible, and all embodiments are included in the scope of the present disclosure. For example, in the above-described embodiments, the position aligner 113 detects a lesion area in which a lesion candidate B is captured as a feature point in an image. However, the position aligner 113 may detect, as a feature point, an area representing a physical characteristic (such as wrinkles and edges) of the subject U in addition to or in place of a lesion area. In addition, the position aligner 113 may perform the position alignment, using a deep learning model instead of the k-nearest neighbors. For example, the position aligner 113 may use a deep learning model for detection of a feature point from an image or may use a deep learning model to identify a correspondence relationship between feature points.

In the above-described embodiments, when generating a synthesized image P4, the image synthesizer 114 performs the synthesis by overlaying a close-up image P3 over the enlarged image P2. However, the image synthesizer 114 may perform the synthesis by making at least one of the enlarged image P2 and the close-up image P3 semi-transparent. The image outputter 115 may be configured to display at least one of the enlarged image P2 and the close-up image P3 in a semi-transparent manner when displaying the synthesized image P4. When making the enlarged image P2 semi-transparent, the image synthesizer 114 may make semi-transparent the whole enlarged image P2 or only an area within the enlarged image P2 in which the close-up image P3 is arranged. Since because of this configuration, the diagnostician can observe both the enlarged image P2 and the close-up image P3 in the area within the enlarged image P2 in which the close-up image P3 is arranged, the diagnostician can diagnose a lesion candidate B in more detail.

In the above-described embodiments, the wide range image P1 and the close-up image P3 are images captured using visible light, infrared light, or ultraviolet light. However, the wide range image P1 and the close-up image P3 may be, without being limited to the above-described images, X-ray images, ultrasonic wave images, magnetic resonance imaging (MRI) images, or the like. In addition, in the above-described embodiments, the wide range image P1 and the close-up image P3 are acquired through image capturing performed by the same single image capturing device 5. However, the wide range image P1 and the close-up image P3 may be, without being limited to images captured by the same image capturing device 5, images captured by different image capturing devices as long as the images are captured under the same type of image capturing condition. As used herein, the same type of image capturing condition means that an observation medium used in the image capturing, such as visible light, infrared light, ultraviolet light, X-rays, and ultrasonic waves, is the same. More specifically, the case where the wide range image P1 and the close-up image P3 are captured under the same type of image capturing condition corresponds to a case where both the wide range image P1 and the close-up image P3 are captured using visible light, a case where both are captured using infrared light, a case where both are captured using ultraviolet light, a case where both are captured using X-rays, a case where both are captured using ultrasonic waves, a case where both are captured using MRI, or the like. Note that in the case where the wide range image P1 and the close-up image P3 are captured by different image capturing devices, the same type of image capturing condition is not limited to a case where wavelengths of electromagnetic waves or ultrasonic waves used in the image capturing completely coincide with each other, and the wavelengths may differ from each other as long as the types of light used by both image capturing devices are visible light, infrared light, ultraviolet light, X-rays, ultrasonic waves, MRI, or the like.

In the above-described embodiments, the wide range image P1 and the close-up image P3 are images in which the skin of the subject U is captured and are images for diagnosing a lesion candidate B existing on the skin of the subject U. However, the wide range image P1 and the close-up image P3 may be images in which a region other than the skin of the subject U is captured. Further, in the above-described embodiments, the wide range image P1 and the close-up image P3 are medical images in which a lesion candidate B existing on the body of the subject U is captured, and the image processing system 1 is a medical assistance system for diagnosing a lesion candidate B. However, the image processing system 1 is not limited to being a medical assistance system. For example, the wide range image P1 and the close-up image P3 may be inspection images in which a construction such as a building, a road, and a bridge is captured as a subject, and the image processing system 1 may be a system that inspects presence or absence of an abnormality in the construction, based on the inspection images. In this case, the feature point for the position aligner 113 to perform position alignment is not a lesion area in which a lesion candidate is captured, but a characteristic structure, shape, or the like that the construction has. In addition, the area of interest is not a lesion area in which a lesion candidate is captured, but an area on the construction captured in the inspection image where there is a possibility that an abnormality, such as a crack and unevenness, has occurred.

In the above-described embodiments, the image processing device 10 includes functional components illustrated in FIG. 2. However, the functional components of the image processing device 10 may, without being limited to being included in a single device, separately exist in a plurality of devices independent of each other. In that case, the plurality of devices may be collectively referred to as an image processing device. In addition, in the above-described embodiments, the image capturing device 5 is a device different from the image processing device 10. However, the image capturing device 5 may be included in the image processing device 10. In other words, the image processing device 10 may be integrated with the image capturing device 5 to constitute a single unit, or may exist at a place located away from the image capturing device 5. In the case where the image processing device 10 is integrated with the image capturing device 5 to constitute a single unit, the integrated unit may also be referred to as an image processing device.

In the above-described embodiments, the processor 11 functions as respective functional components illustrated in FIG. 2 by the CPU executing programs stored in the ROM or the storage 12. However, the processor 11 may be dedicated hardware. The dedicated hardware is, for example, a single circuit, a composite circuit, a programmed processor, an application specific integrated circuit (ASIC), a field-programmable gate array (FPGA), or a combination of the foregoing. In the case where the processor 11 is dedicated hardware, each of the functions of the functional components may be achieved by an individual piece of hardware, or the functions of the functional components may be collectively achieved by a single piece of hardware. In addition, among the functions of the functional components, some functions may be achieved by dedicated hardware and the other functions may be achieved by software or firmware. As described above, the processor 11 can achieve the above-described functions by hardware, software, firmware, or a combination of the foregoing.

By applying a program that defines the operation of the above-described image processing device 10 to a computer, such as a personal computer and a cloud server, it is possible to cause the computer to function as the above-described image processing device 10. In addition, a method for distributing such a program is arbitrarily determined, and the program may be distributed stored in a non-transitory computer-readable recording medium, such as a compact disk ROM (CD-ROM), a digital versatile disk (DVD), a magneto optical disk (MO), and a memory card, or may be distributed via a communication network, such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An image processing device including one or more processors to execute processing, comprising:
acquiring a first image in which a subject is captured;
acquiring a second image in which the subject is captured that corresponds to a partial range within an image capturing range of the first image and that is captured under a same type of image capturing condition as the first image;
performing position alignment between the first image and the second image; and
arranging the second image at a position determined by the position alignment in the first image.

2. The image processing device according to claim 1, wherein the first image and the second image are captured by a same image capturing device.

3. The image processing device according to claim 1, wherein the second image is captured with a higher spatial resolution than the first image.

4. The image processing device according to claim 1, wherein the one or more processors detect an area of interest from within the first image and display a position of the detected area of interest as a target position in a case where a user captures the second image.

5. The image processing device according to claim 4, wherein in a case where the one or more processors detect a plurality of areas of interest from within the first image, the one or more processors determine the target position, based on a density distribution of the plurality of areas of interest within the first image.

6. The image processing device according to claim 4, wherein the first image is an image in which a lesion candidate existing on a body of the subject is captured and the area of interest is an area in which the lesion candidate is captured.

7. An image processing method, comprising, by a computer:
acquiring a first image in which a subject is captured;
acquiring a second image in which the subject is captured that corresponds to a partial range within an image capturing range of the first image and that is captured under a same type of image capturing condition as the first image;
performing position alignment between the first image and the second image; and
arranging the second image at a position determined by the position alignment in the first image.

8. A system including one or more processors to execute processing, comprising:
acquiring a first image in which a subject is captured;
acquiring a second image in which the subject is captured that corresponds to a partial range within an image capturing range of the first image and that is captured under a same type of image capturing condition as the first image;
performing position alignment between the first image and the second image; and
arranging the second image at a position determined by the position alignment in the first image.
